(19) United States
(12) Patent Application Publication
(10) Pub. No.: US 2017/0109031 A1
(43) Pub. Date: Apr. 20, 2017

(54) DISPLAY DEVICE, IMAGE FORMING APPARATUS, AND METHOD FOR CONTROLLING DISPLAY DEVICE

(71) Applicant: KYOCERA Document Solutions Inc., Osaka (JP)

(72) Inventor: Satoshi ITO, Osaka (JP)

(73) Assignee: KYOCERA Document Solutions Inc., Osaka (JP)

(21) Appl. No.: 15/287,160

(22) Filed: Oct. 6, 2016

(30) Foreign Application Priority Data
Oct. 14, 2015 (JP) 2015-202997

(51) Int. Cl. G06F 3/0485; G06F 3/0488

(52) U.S. Cl. CPC G06F 3/04855; G06F 3/0488

(57) ABSTRACT

A display device includes a processing unit including a control circuit, a display panel that displays contents of a page and a horizontal scroll bar including a button image and a groove image indicating a slide range of the button image, and a touch panel that receives an operation to a displayed image. The processing unit moves a display area of the display panel in a horizontal direction based on a movement direction and a movement amount of the button image. The processing unit determines a contents end position that is a rightmost position of the contents in a band area having an upper end and a lower end respectively corresponding to an upper end and a lower end of the display area of the display panel, and controls the display panel to display the contents end position.

### INCORPORATION BY REFERENCE

This application is based upon and claims the benefit of priority from the corresponding Japanese Patent Application No. 2015-202997 filed Oct. 14, 2015, the entire contents of which are hereby incorporated by reference.

### BACKGROUND

The present disclosure relates to a display device for displaying pages and to an image forming apparatus including the display device.

A display device such as a smart phone or a tablet computer, which includes a combination of a display panel and a touch panel unit so as to display various information and screens according to user's operation. With this display device, it is possible to access websites, to obtain contents such as images and character strings, to display web pages, and to open files containing contents such as documents and images so as to display the file contents (pages). An example of the display device is known as follows.

Specifically, there is known a mobile terminal, in which conditions (character string, image, text box, button, and coordinate point) of a location to be displayed in a web page are stored with priority orders in a storage unit. When a processing unit controls a display unit to display the web page, a location matching the conditions having a highest priority order is detected, and a display range is moved so that the detected location is displayed at a predetermined position (such as an upper left part, an upper middle part, an upper right part, a left part, a middle part, a right part, a lower left part, a lower middle part, or a lower right part) on the display unit. With this structure, even an information device such as a mobile terminal having only a small display unit can quickly display a part containing information to be displayed with higher priority without repeating scroll operation or the like.

As to a page having a large vertical width or a large horizontal width, the entire page cannot be displayed in one screen. For example, a web page for PCs may have an area larger than an area that a smart phone can display in one screen. In addition, there is a web page having a larger area than a PC display. In this case, a display area (the screen) is scrolled so that an area out of the display screen is newly displayed. When browsing the entire page, this scroll operation is repeated. For the purpose of scrolling the display area, a scroll bar may be displayed on the screen.

When searching for contents (information such as images, texts, or character strings) that a user wants to view, the user searches while scrolling the display area. However, the page is not always filled fully with contents (from an end to the other end). For convenience of layout, there is a blank part without contents (with only a background image) in the page.

Conventionally, there is a problem that it cannot be checked whether there are contents in the new scrolled part or not without scrolling. Pages are basically written with left alignment. When the user does not know whether or not there are contents on the right side of the current display area, the user may try to scroll right. When the newly displayed area in the process of scrolling to the right end is only a blank area, the scroll to the right is consequently a wasteful operation.

Further, in the conventional technique described above, a location of an area to be displayed in a page is automatically determined based on a priority condition. However, information wanted by the user changes every time, and hence the display location is automatically moved to a part that the user does not want. In addition, whether or not there are contents on the right side of the current display area is not known unless the scroll operation is performed.

### SUMMARY

A display device according to one aspect of the present disclosure includes a display panel, a touch panel, and a processing unit. The display panel displays contents of a page and a horizontal scroll bar including a button image and a groove image indicating a slide range of the button image. The touch panel is provided to the display panel so as to receive an operation to a displayed image. The processing unit includes a control circuit. The processing unit controls display on the display panel, recognizes content of the operation to the displayed image based on an output of the touch panel, and moves a display area of the display panel in a horizontal direction based on a movement direction and a movement amount of the button image of the horizontal scroll bar. When a horizontal width of the page is larger than a horizontal width of the display area of the display panel, the processing unit determines a contents end position that is a rightmost position of the contents in a band area that is an area in the page having an upper end and a lower end respectively corresponding to an upper end and a lower end of the display area of the display panel from a left end to a right end of the page, and controls the display panel to display the horizontal scroll bar indicating the contents end position.

Further features and advantages of the present disclosure will become apparent from the description of embodiments given below.

### BRIEF DESCRIPTION OF THE DRAWINGS

FIG. 1 is a diagram illustrating an example of a multifunction peripheral according to an embodiment.

FIG. 2 is a diagram illustrating an example of an external view of a display device according to the embodiment.

FIG. 3 is an explanatory diagram illustrating an example of the display device according to the embodiment.

FIG. 4 is a diagram illustrating an example of a relationship between the entire page and a display area of the display device.

FIG. 5 is a diagram illustrating an example of a horizontal scroll bar.

FIG. 6 is a diagram illustrating an example of a horizontal scroll setting screen according to the embodiment.

FIG. 7 is a diagram illustrating an example of a flow of displaying a mark image according to the embodiment.

FIG. 8 is a diagram illustrating an example of a display area with respect to the entire page.

FIG. 9 is a diagram illustrating an example of a display of the mark image on the display device according to the embodiment.

FIG. 10 is a diagram illustrating an example of the display area with respect to the entire page.

FIG. 11 is a diagram illustrating an example of a display of the mark image on the display device according to the embodiment.

FIG. 12 is a diagram illustrating an example of a scroll restriction process according to the embodiment.

FIG. 13 is a diagram illustrating an example of a flow of a display in a groove image change mode according to the embodiment.

FIG. 14 is a diagram illustrating an example of a display area with respect to the entire page.

FIG. 15 is a diagram illustrating an example of a horizontal width change of the groove image according to the embodiment.

### DETAILED DESCRIPTION

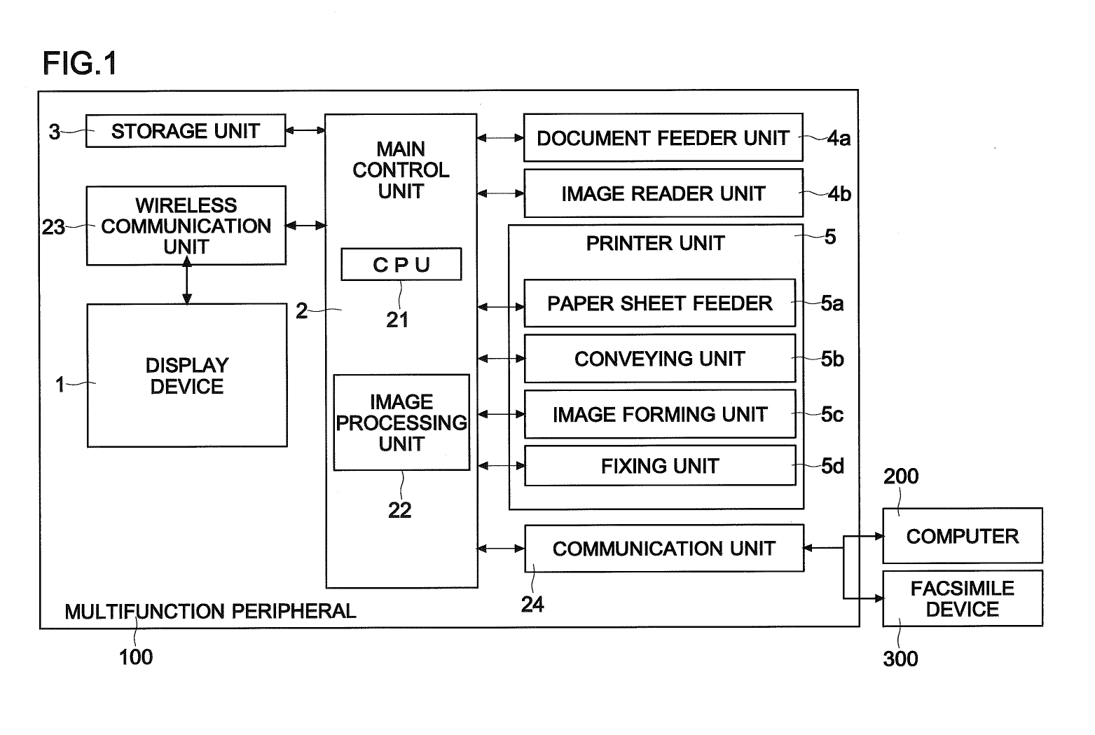

In view of the problem of the conventional technique described above, according to the present disclosure, information indicating that there are no contents on a right side of a current position in a band area in a left and right direction including a current display area is displayed, so that wasteful scroll in the right direction of the display area is eliminated. An embodiment of the present disclosure is described below with reference to FIGS. 1 to 15. Note that in this embodiment, a multifunction peripheral 100 is exemplified as an image forming apparatus including a display device 1 for description. However, individual elements such as structures and arrangements described in this embodiment are merely examples for description and should not be interpreted as limiting the scope of the disclosure.

(Outline of Multifunction Peripheral 100)

With reference to FIG. 1, a multifunction peripheral 100 according to the embodiment is described. The multifunction peripheral 100 includes a display device 1. In addition, the multifunction peripheral 100 includes a main control unit 2 and a storage unit 3 (see FIG. 1). The main control unit 2 includes a CPU 21 and an image processing unit 22. The main control unit 2 controls operation of the multifunction peripheral 100. The storage unit 3 is a combination of a nonvolatile storage device such as a ROM and an HDD and a volatile storage device such as a RAM. The storage unit 3 stores various programs and data for controlling the multifunction peripheral 100, and various data such as set data and image data. The CPU 21 performs control of the multifunction peripheral 100, various calculations, and desired signal processing based on the programs and data stored in the storage unit 3. The image processing unit 22 performs processings and calculations such as image processing on the image data used for printing or transmission.

As illustrated in FIG. 1, the multifunction peripheral 100 includes the display device 1. A smart phone and a tablet computer 200 owned by each user can be used as the display device 1. In this case, an application 6 for setting the multifunction peripheral 100 and communicating with the multifunction peripheral 100 is installed in the display device 1 of each user. In addition, the display device 1 may also be a dedicated device for setting the multifunction peripheral 100 (a mobile terminal including a display panel and a touch panel unit, included in the same package as the multifunction peripheral 100). In other words, the smart phone, the tablet computer 200, and the dedicated display device 1 for the multifunction peripheral 100 can be used as an operation panel for setting. The main control unit 2 communicates with the display device 1 via a wireless communication unit 23. Then, the main control unit 2 recognizes set content based on an operation made by the display device 1. Note that the display device 1 may be fixed to the multifunction peripheral 100, and the main control unit 2 and the display device 1 may be connected with cable.

The multifunction peripheral 100 includes a document feeder unit 4a and an image reader unit 4b. The main control unit 2 controls the document feeder unit 4a to feed a set document sheet to a reading position. The main control unit 2 controls the image reader unit 4b to read the document sheet fed by the document feeder unit 4a or a document set on a contact glass for place reading (not shown). Then, the main control unit 2 controls the image reader unit 4b to generate the image data. The main control unit 2 controls the document feeder unit 4a and the image reader unit 4b to operate in a job such as scanning, printing, or transmission.

A printer unit 5 (a paper sheet feeder 5a, a conveying unit 5b, an image forming unit 5c, and a fixing unit 5d) performs printing on a paper sheet using toner based on the image data. In a job accompanied with printing, the main control unit 2 controls the paper sheet feeder 5a to supply paper sheets one by one to the conveying unit 5b. The main control unit 2 controls the conveying unit 5b to convey the paper sheet supplied from the paper sheet feeder 5a. The main control unit 2 controls the image forming unit 5c to form a toner image based on the image data, and controls the image forming unit 5c to transfer the toner image onto the conveyed paper sheet. The main control unit 2 controls the fixing unit 5d to fix the transferred toner image on the paper sheet. The paper sheet with the fixed toner is discharged to the outside of the apparatus.

The multifunction peripheral 100 includes a communication unit 24. The communication unit 24 includes various connectors, sockets, and a communication chip. The communication unit 24 is connected to the computer 200 such as a PC or a server and a facsimile device 300 in a communicable manner via a network or a cable. The communication unit 24 receives data from the computer 200 or the facsimile device 300. The main control unit 2 controls the printer unit 5 to perform printing based on the data received by the communication unit 24 (a print job). In addition, the communication unit 24 transmits data to the computer 200 or the facsimile device 300 (a transmission job). For example, the main control unit 2 controls the communication unit 24 to transmit the image data obtained by reading the document.

(Display Device 1)

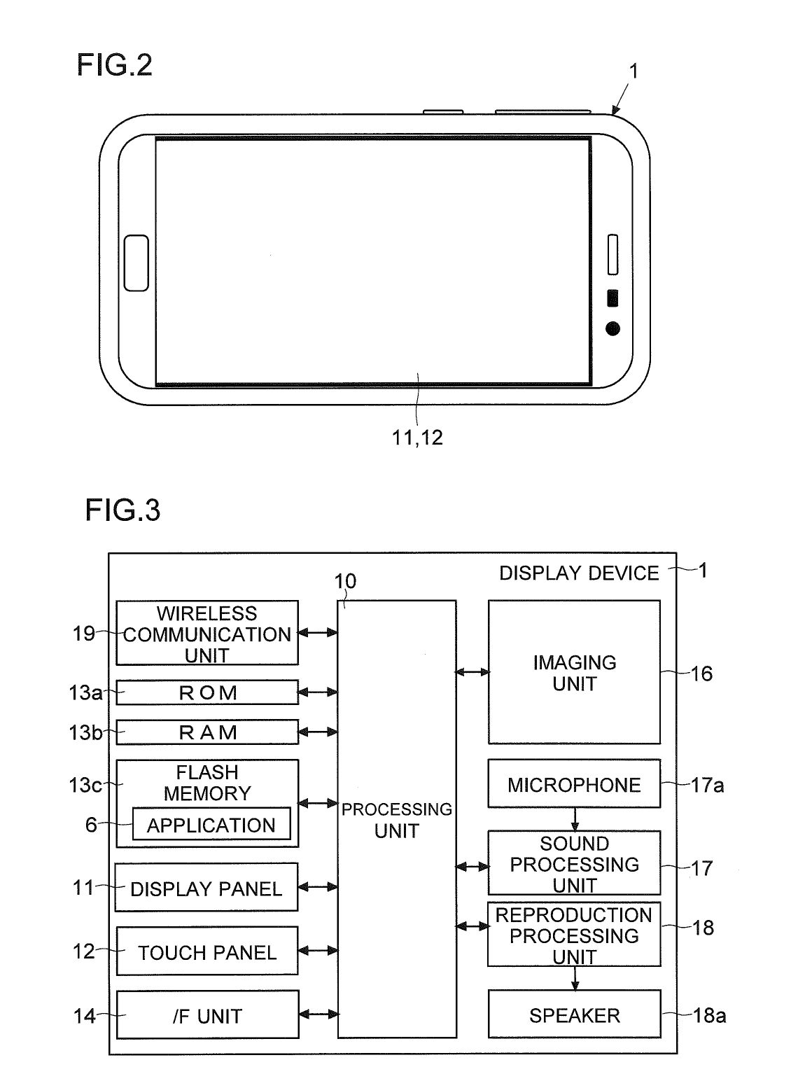

With reference to FIGS. 2 and 3, an outline of the display device 1 according to the embodiment is described below. FIG. 2 illustrates an example of the display device 1. The display device 1 of FIG. 2 is a smart phone. As illustrated in FIG. 2, the display device 1 includes a display panel 11. A touch panel 12 (input receiving portion) is provided to the display panel 11. The user can perform various operations by touching the touch panel 12.

As illustrated in FIG. 3, the display device 1 includes a processing unit 10 (a control chip), a ROM 13a, a RAM 13b, a flash memory 13c, the display panel 11, the touch panel 12, an I/F unit 14, an imaging unit 16, a sound processing unit 17, a microphone 17a, a reproduction processing unit 18, a speaker 18a, and a wireless communication unit 19. Further, in the case where the display device 1 is the dedicated device included in the same package as the multifunction peripheral 100, it does not need to include the imaging unit 16, the sound processing unit 17, the microphone 17a, the reproduction processing unit 18, and the speaker 18a, but instead may include another member such as a hardware key and another circuit.

The processing unit 10 is a chip including a plurality of circuits such as a control circuit, a calculation processing circuit, an image processing circuit, and a display control circuit (e.g. an SoC). The processing unit 10 controls operation of the display device 1 based on an OS and the application 6 of the display device 1. The processing unit 10 controls display on the display panel 11.

The ROM 13a and the flash memory 13c store a control program, control data, and the application 6 of the display device 1. The processing unit 10 controls individual portions of the display device 1 based on the control program, the control data, and the application 6 stored in the ROM 13a and the flash memory 13c. In addition, the flash memory 13c can store a plurality of downloaded applications 6 (note that only one of the applications 6 is illustrated in FIG. 3). In response to a user's request to start the application 6 via the touch panel 12, the processing unit 10 can read the application 6 and the program from the flash memory 13c onto the RAM 13b and can execute the same.

The processing unit 10 controls the display panel 11 to display various information. The touch panel 12 is connected to the processing unit 10. The processing unit 10 recognizes a touched position based on an output of the touch panel 12. Then, the processing unit 10 recognizes the touched object among icons, buttons, and keys displayed on the display panel 11. By pressing an image for operation such as an icon, a button, or a key, it is possible to instruct an operation of the display device 1 such as start of the application 6.

The I/F unit 14 is equipped with a connector, a socket, and a communication chip based on various standards. The I/F unit 14 reads and writes data and programs from and to a recording medium such as a memory card inserted in the I/F unit 14. The imaging unit 16 is a camera provided to the display device 1. The imaging unit 16 processes an analog signal obtained by imaging so as to generate digital image data.

The wireless communication unit 19 includes an antenna and a communication circuit. The wireless communication unit 19 performs communication with a network such as a data communication network and the multifunction peripheral 100 according to an instruction from the processing unit 10. For example, via the wireless communication unit 19, it is possible to perform data communication with the multifunction peripheral 100 about setting of the multifunction peripheral 100, and to download the application 6 via the network. In addition, the wireless communication unit 19 performs transmission and reception of sound data, and can also be used for talking with the other side over the telephone.

The sound processing unit 17 performs signal processing on a sound signal input from the microphone 17a into a form that can be transmitted from the wireless communication unit 19. The reproduction processing unit 18 reproduce the sound data received by the wireless communication unit 19 from the other side so that the speaker reproduces the sound.

The display device 1 starts the application 6 for setting the multifunction peripheral 100 and can make setting of jobs such as printing and transmission by the multifunction peripheral 100 and system setting of the multifunction peripheral 100. When starting the application 6, the user makes setting by touching a display position of an image displayed on the display panel 11. When setting completion is input to the touch panel 12, the processing unit 10 controls the wireless communication unit 19 of the display device 1 to transmit set content data to the wireless communication unit 23 of the multifunction peripheral 100. The main control unit 2 of the multifunction peripheral 100 executes a job based on the received set content data or changes the system setting based on the received set content data.

By starting a browser so as to input to the touch panel 12, the display device 1 can access to a website and browse a web page. When the browser is started, and a website (URL) to be accessed is designated by an operation to the touch panel 12, the processing unit 10 controls the wireless communication unit 19 to access to the designated website. The processing unit 10 controls the wireless communication unit 19 to obtain information of the website (various information such as contents of character strings and images, description languages, and resources). Then, the processing unit 10 analyzes the information obtained based on the browser. In addition, the processing unit 10 controls the display panel 11 to display a page P in which character strings and images are arranged, based on the browser and a result of the analysis.

The display device 1 can also open a document file and an image file so as to browse contents thereof (the page P). Specifically, when the application 6 for browsing the document file or the image file is started and the file to be browsed is designated by an operation to the touch panel 12, the processing unit 10 analyzes the designated file and controls the display panel 11 to display the file (the page P) including character strings and images.

(Scroll in Page Display)

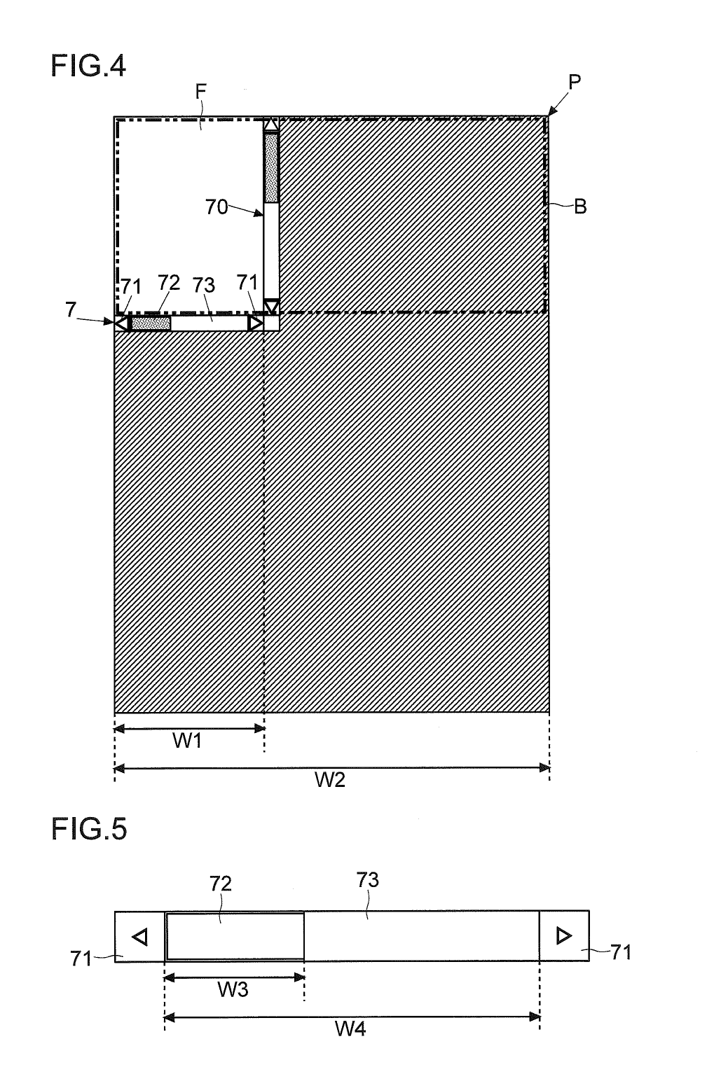

With reference to FIGS. 4 and 5, scroll in page display is described. In FIG. 4, a large rectangle (with hatching) indicates the entire page to be browsed on the display device 1. In this page P, contents such as texts, character strings, symbol strings, and images (still images and moving images) are arranged. FIG. 4 illustrates an example in the state where the upper left corner of a display area F of the display panel 11 is identical to the upper left corner of the page P (an initial state of browsing the page).

When the page P is larger than the display area F of the display panel 11, the processing unit 10 controls the display panel 11 to display a part of the page P. FIG. 4 illustrates an example in which the page P is larger than the display area F both in the vertical width and in the horizontal width. In this case, the user moves the display area F by scroll so as to check contents of the page P. When scrolling is necessary for browsing, the processing unit 10 controls the display panel 11 to display a vertical scroll bar 70 on the right end for scroll in the vertical direction. In addition, the processing unit 10 controls the display panel 11 to display a horizontal scroll bar 7 on the lower end for scroll in the horizontal (left and right) direction.

The processing unit 10 recognizes an operation to the vertical scroll bar 70 based on the output of the touch panel 12, and moves the display area F in the vertical direction according to the operation content. In addition, the processing unit 10 recognizes an operation to the horizontal scroll bar 7 based on the output of the touch panel 12, and moves the display area F in the horizontal direction according to the operation content.

Next, the horizontal scroll bar 7 is described with reference to FIG. 5. The horizontal scroll bar 7 includes arrow images 71 (scroll arrows, one in the right direction and the other in the left direction), a button image 72 (scroll thumb), and a groove image 73 (scroll track). The groove image 73 indicates a slide range of the button image 72. The button image 72 can be moved to slide in the range of the groove image 73. The button image 72 can be moved by a drag operation (operation of touching and moving the touched position while keeping the touched state). When the button image 72 is touched and the touched position is moved to left or right while the touched state is maintained, the processing unit 10 controls the display panel 11 to scroll the display area F in the same direction as the moving direction of the button image 72. In addition, the processing unit 10 sets a scroll amount (movement amount) of the display area F larger as a movement amount of the button image 72 is larger.

The processing unit 10 calculates a first ratio (W1/W2) by dividing a horizontal width W1 of the display area F by a horizontal width W2 of the page P (see FIG. 4). Because the horizontal width W2 of the page P is larger, the calculated first ratio is smaller than one. Further, the processing unit 10 multiplies a horizontal width W4 of the groove image 73 by the first ratio to obtain a length (W4×W1/W2), and sets the length as a horizontal width W3 of the button image 72. In this way, a ratio between the horizontal width W3 of the button image 72 and the horizontal width W4 of the groove image 73 in the horizontal scroll bar 7 is identical to a ratio between the horizontal width W1 of the display area F and the horizontal width W2 of the page P.

A ratio obtained by dividing a distance between the left end of the page P and the center of the display area F in the horizontal direction by the horizontal width W2 of the page P is identical or substantially identical to a ratio obtained by dividing a distance between the left end of the groove image 73 and the center of the button image 72 in the horizontal direction by the horizontal width W4 of the groove image 73. In addition, a ratio obtained by dividing a distance between the left end of the page P and the left end of the current display area F by the horizontal width W2 of the page P is identical or substantially identical to a ratio obtained by dividing a distance between the left end of the groove image 73 and the left end of the button image 72 at the current position by the horizontal width W4 of the groove image 73. In addition, a ratio obtained by dividing a distance between the left end of the page P and the right end of the current display area F by the horizontal width W2 of the page P is identical or substantially identical to a ratio obtained by dividing a distance between the left end of the groove image 73 and the right end of the button image 72 at the current position by the horizontal width W4 of the groove image 73. In other words, a width of a band area B that is an area in the page P having an upper end and a lower end respectively corresponding to the upper end and the lower end of the display area F of the display panel 11 from the left end to the right end of the page P corresponds to the width of the groove image 73. The width of the button image 72 corresponds to the width of the display area F. A position of the button image 72 corresponds to a position of the display area F in the band area B.

(Mode Setting of Horizontal Scroll Bar 7)

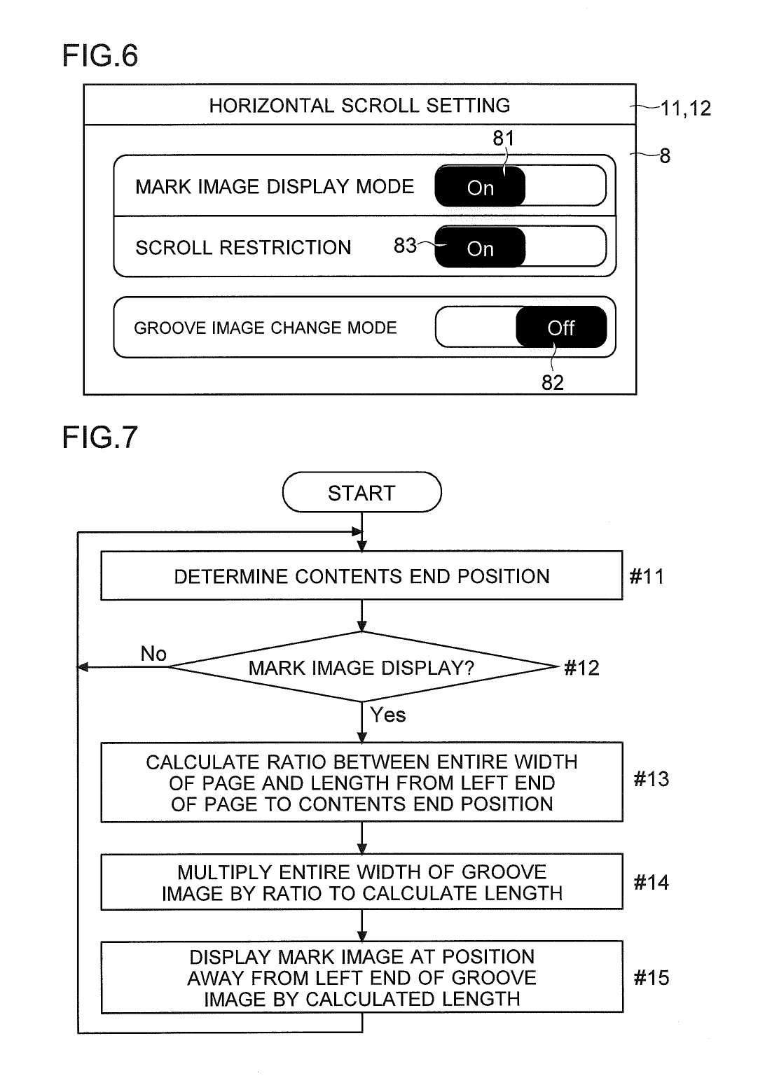

Next, with reference to FIG. 6, a display mode of the horizontal scroll bar 7 of the display device 1 according to the embodiment is described.

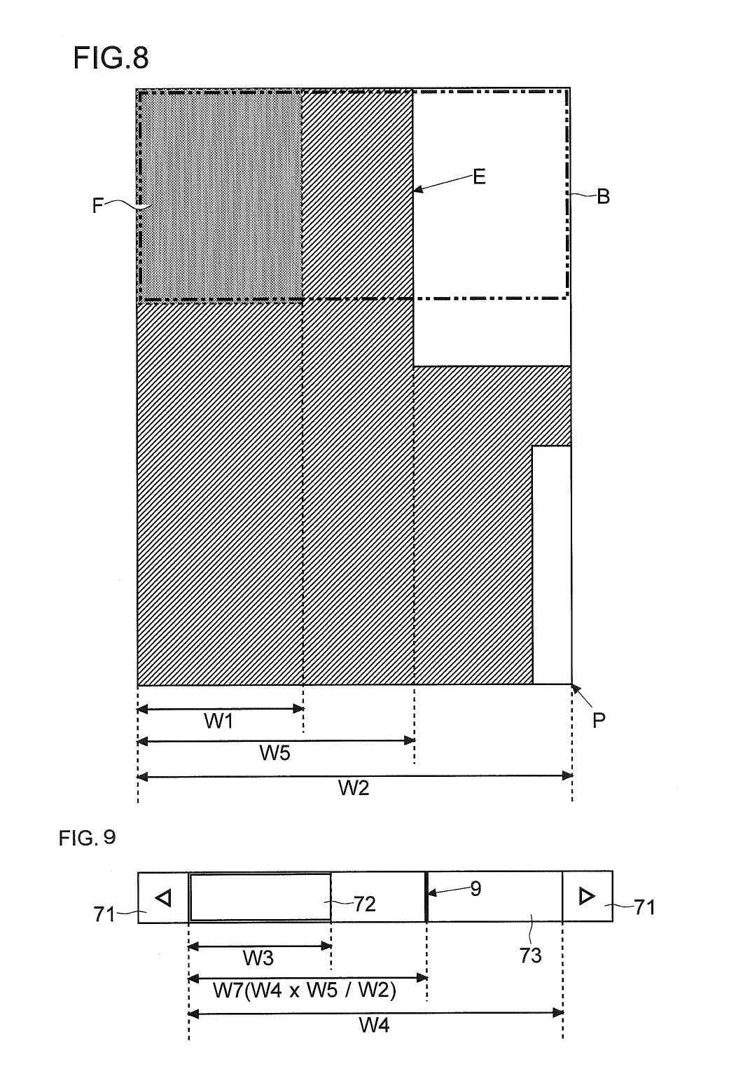

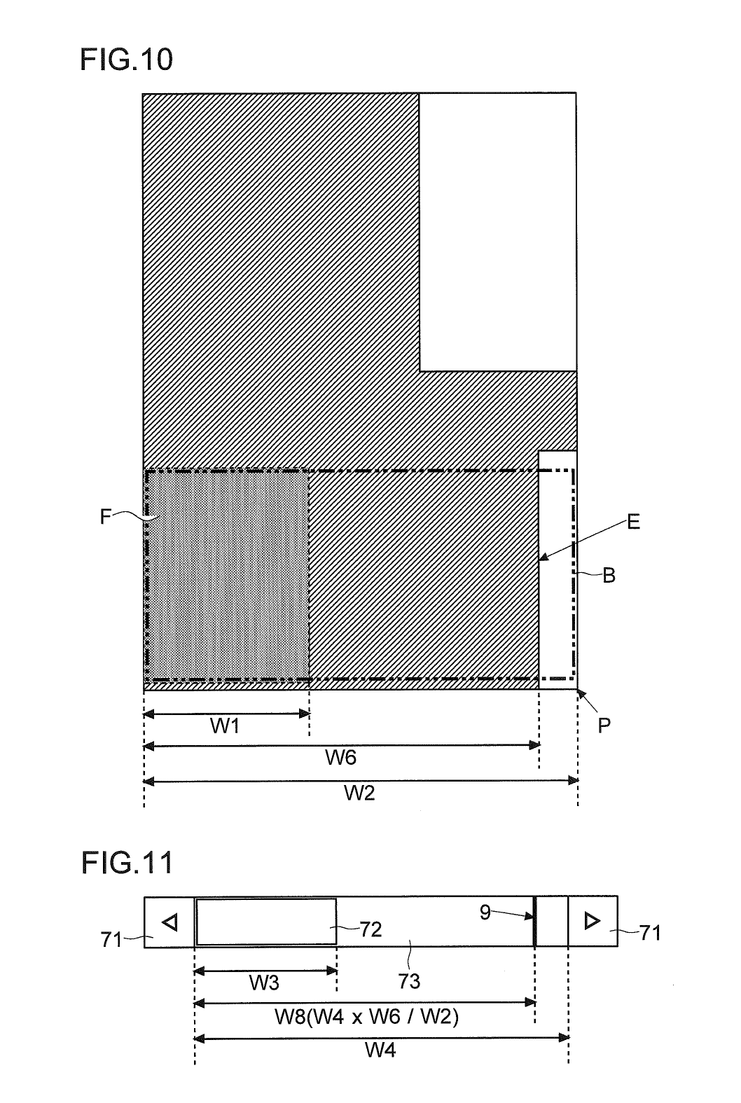

In the page, an area without contents is an area where information that is valid for the user is not described. Therefore, when the horizontal width of the page P is larger than the horizontal width of the display area F of the display panel 11, the processing unit 10 determines a contents end position E that is the rightmost position of the contents in the band area B (see FIGS. 8 and 10). Then, the processing unit 10 controls the display panel 11 to display the horizontal scroll bar 7 indicating the contents end position E.

Specifically, the display device 1 has a mark image mode in which the display panel 11 displays the horizontal scroll bar 7 with a mark image 9 indicating the contents end position E (described later in detail), and a groove image change mode in which the display panel 11 displays the horizontal scroll bar 7 with a shortened horizontal width of the groove image 73 (described later in detail). It is possible to select (set) the mode by operating the touch panel 12 in a horizontal scroll setting screen 8 (see FIG. 6). When a predetermined operation is made to the touch panel 12, the processing unit 10 controls the display panel 11 to display the horizontal scroll setting screen 8.

The horizontal scroll setting screen 8 is provided with a mark image mode button 81 for setting whether or not to display the mark image 9. By touching the mark image mode button 81 and sliding the touched position in the horizontal direction while keeping the touched state, ON/OFF of the mark image mode can be switched. In other words, the touch panel 12 receives setting whether or not to display in the mark image mode. When the setting to display the mark image 9 (setting of mark image mode ON) is made, the processing unit 10 controls the display panel 11 to display the mark image 9. When the setting not to display the mark image 9 (setting of mark image mode OFF) is made, the processing unit 10 does not control the display panel 11 to display the mark image 9.

In addition, the horizontal scroll setting screen 8 is also provided with a groove image change mode button 82 for setting whether or not to change the horizontal width of the groove image 73 according to the contents end position E. By touching the groove image change mode button 82 and sliding the touched position in the horizontal direction while keeping the touched state, ON/OFF of the groove image change mode can be switched. In other words, the touch panel 12 receives setting to determine whether or not to change the horizontal width of the groove image 73 according to the contents end position E. When the setting is “ON”, the processing unit 10 changes the horizontal width of the groove image 73 according to the contents end position E. When the setting is “OFF”, the processing unit 10 does not change the horizontal width of the groove image 73 according to the contents end position E.

Note that when an operation of setting the mark image mode button 81 to an ON state is made, the groove image change mode button 82 automatically becomes an OFF state. On the other hand, when an operation of setting the groove image change mode button 82 to an ON state is made, the mark image mode button 81 automatically becomes an OFF state. In other words, only one of the mark image mode and the groove image change mode can be selected.

(Mark Image Mode)

Next, with reference to FIGS. 7 to 11, an example of a display in the mark image mode on the display device 1 according to the embodiment is described. In FIGS. 8 and 10, a rectangle with hatching enclosed by broken lines indicates the display area F of the display device 1. Further in FIGS. 8 and 10, a solid line frame (rectangle) indicates the entire page. In addition, slant-hatched areas in FIGS. 8 and 10 indicate areas having contents in the page. White backgrounds in the page P in FIGS. 8 and 10 indicate areas having no contents (a blank part with only a background image).

With reference to FIG. 7, a flow of the display of the mark image 9 is described below. The flow of FIG. 7 starts when starting to browse the page P such as a web page with the display device 1. In addition, the flow of FIG. 7 is repeated until the browsing of the page P is finished (until being switched to another screen).

First, the processing unit 10 determines the contents end position E that is the rightmost position of the contents in the band area B from the left end to the right end of the page P overlapping with the display area F of the display panel 11 (Step #11).

The processing unit 10 determines the band area B in the left and right direction in the page overlapping with the area displayed on the display panel 11. Then, the processing unit 10 recognizes a position of the right end of the contents in each line in the left and right direction included in the band area B. In FIGS. 8 and 10, the line indicating the position of the right end of the contents in the page P is illustrated by a solid line. The processing unit 10 recognizes this line. Then, the processing unit 10 determines the rightmost position among the right end positions of the contents in individual lines as the contents end position E.

In addition, when starting to display the page P, the processing unit 10 analyzes a structure of the page P and arranges text and image contents in the page P. Therefore the processing unit 10 may recognize the position of the right end of the contents in each line in the left and right direction included in the page P (the right end of images and texts) when structuring and arranging the page P, and may store the data indicating the right end position of each line in the RAM 13b. In this case, the processing unit 10 refers to the data in the RAM 13b so as to determine the rightmost position among the right end positions of the contents in individual lines of the part of the page P displayed on the display panel 11 as the contents end position E.

The processing unit 10 determines whether or not to display the mark image 9 (Step #12). The processing unit 10 determines not to display the mark image 9 when the contents end position E overlaps with the right end of the page P. The processing unit 10 determines to display the mark image 9 when the contents end position E is inside the right end of the page P (when it does not overlap with the right end). When displaying the mark image 9 (Yes in Step #12), in order to determine a display position of the mark image 9, the processing unit 10 calculates a ratio between the horizontal width (entire width) of the page P and a distance from the left end of the page P to the contents end position E (Step #13).

FIG. 8 illustrates an example of the state where the display panel 11 displays an upper left part of the page. FIG. 10 illustrates an example of the state where the area displayed on the display panel 11 is shifted downward from the state of FIG. 8. The contents end position E is closer to the right end in the state of FIG. 10 than in the state of FIG. 8.

In FIGS. 8 and 10, the left and right width (entire width) of the display area F of the display panel 11 is indicated by the horizontal width W1. In addition, in FIGS. 8 and 10, the left and right width (entire width) of the entire page is the horizontal width W2. In addition, in FIG. 8, the distance from the left end of the page P to the contents end position E is indicated by a horizontal width W5. In addition, in FIG. 10, the distance from the left end of the page P to the contents end position E is indicated by a horizontal width W6.

In Step #13, the processing unit 10 calculates a ratio of the horizontal width W5 to the horizontal width W2 in the state of FIG. 8. In addition, in Step #13, the processing unit 10 calculates a ratio of the horizontal width W6 to the horizontal width W2 in the state of FIG. 10.

Next, the processing unit 10 multiplies the entire width of the groove image 73 by the calculated ratio to determine the length (Step #14). In FIGS. 9 and 11, the entire width (left and right width) of the groove image 73 is indicated by the horizontal width W4. In addition, in FIG. 9, the width (length) obtained by multiplying the entire width of the groove image 73 by the calculated ratio is indicated by a horizontal width W7. In FIG. 9, a relationship of (horizontal width W4)×(horizontal width W5)/(horizontal width W2)=(horizontal width W7) is satisfied. In addition, in FIG. 11, the width obtained by multiplying the entire width of the groove image 73 by the calculated ratio is indicated by a horizontal width W8. In FIG. 11, a relationship of (horizontal width W4)×(horizontal width W6)/(horizontal width W2)=(horizontal width W8) is satisfied. In other words, the processing unit 10 calculates the length by multiplying the entire width of the groove image 73 by the calculated ratio.

The processing unit 10 controls to display the mark image 9 at a position apart from the left end of the groove image 73 by the calculated length (Step #15). In this way, it is possible to know that there are no contents to be newly displayed even if a right scroll is further made from the state where the button image 72 overlaps with the mark image 9. In addition, the state, in which the mark image 9 is displayed on the groove image 73 overlapping with the button image 72 and the right end of the button image 72 is identical to the mark image 9, is the state where there are no more contents on the right side. Thus, it is possible to visually show that the right end of the display area F overlaps with or is close to the contents end position E.

FIGS. 9 and 11 illustrate an example in which the mark image 9 is displayed as a thick vertical line. The mark image 9 may have a conspicuous color such as red color. In addition, an image other than the line image such as a triangle, circle, rectangle, or star may be added to the upper or lower end of the mark image 9 of the vertical line. Here, the contents end position E may be changed according to a position in the vertical direction of the display area F of the display panel 11 in the page. Therefore, as illustrated in FIGS. 9 and 11, the processing unit 10 sets the display position of the mark image 9 to a position corresponding to the contents end position E.

In the case of No in Step #12 (when it is not necessary to display the mark image 9), and after Step #15, the flow returns to Step #11. The processing unit 10 performs Step #11 at a constant period during display of the page P. In this way, even if the display area F of the display panel 11 is moved, the display position of the mark image 9 becomes a position corresponding to the contents end position E of the display area F after the movement.

(Scroll Restriction Process)

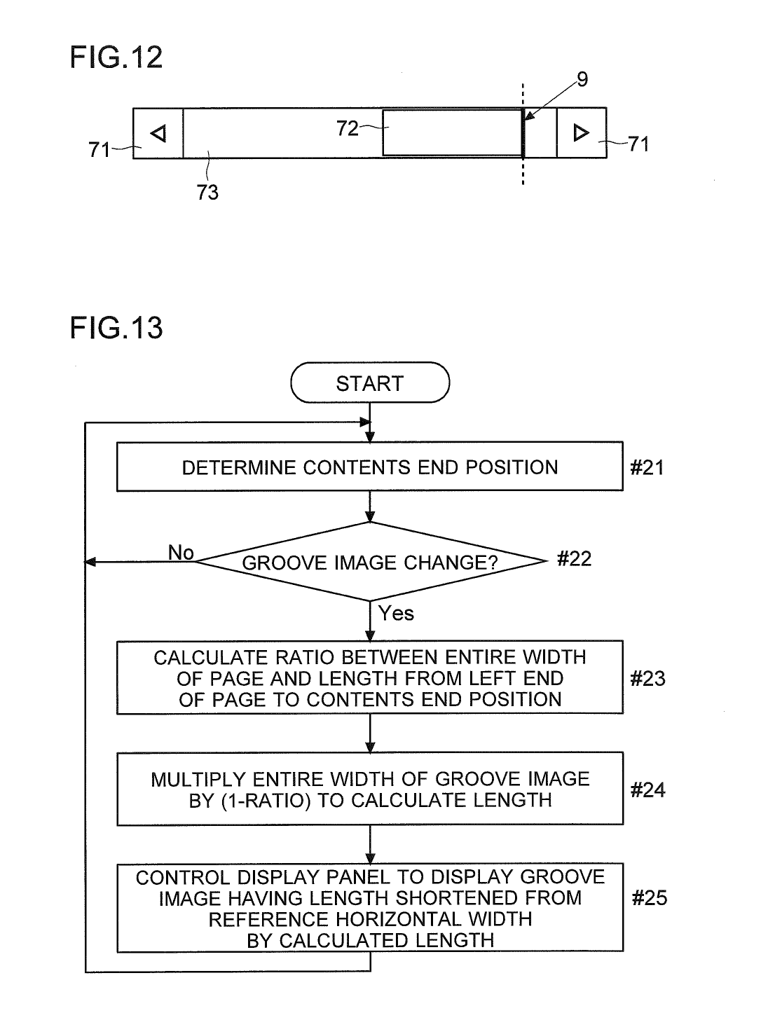

Next, with reference to FIGS. 6 and 12, a scroll restriction process in the mark image mode according to the embodiment is described. There are no contents on the right side of the contents end position E. Therefore, useful information is not displayed by the right scroll from the contents end position E, and such horizontal scroll is wasteful. The scroll restriction process is a process of restricting (inhibiting) the right scroll from the contents end position E.

A display position of the mark image 9 attached to the groove image 73 in the horizontal scroll bar 7 corresponds to the contents end position E of the band area B in the page P. Therefore the state where the right end of the button image 72 overlaps with the mark image 9 (see FIG. 12) is the state where there are no contents on the right side of the current display area F on the display panel 11. In other words, the processing unit 10 controls the display panel 11 to display the mark image 9 so that the state where the right end of the button image 72 overlaps with the mark image 9 becomes the state where the right end of the display area F overlaps with the contents end position E. In this way, the user can recognize the contents end position E of the current band area B. In addition, the user can check whether or not the current display area F is located at the rightmost end of the contents by viewing the horizontal scroll bar 7. Then, in the display device 1, when an operation for moving the button image 72 is made in the state where the mark image 9 is displayed, the processing unit 10 can perform the scroll restriction process for inhibiting the right end of the button image 72 from moving to the right side of the mark image 9. In this way, the right scroll that does not cause display of new contents can be forcibly inhibited. Thus, wasteful right scroll operation can be eliminated.

When the setting to perform the scroll restriction process is made, the processing unit 10 does not accept the operation for moving the button image 72 to the right side of the mark image 9 and ignores the operation. Specifically, in the state where the right end of the button image 72 overlaps with the mark image 9 (the state of FIG. 12), when the operation for further moving the button image 72 to the right side is made with the touch panel 12, the processing unit 10 does not control the display panel 11 to move the display to the right side of the contents end position E.

Here, whether or not to perform the scroll restriction process can be set on the horizontal scroll setting screen 8 (see FIG. 6). The horizontal scroll setting screen 8 is provided with a scroll restriction process setting button 83 for setting whether or not to perform the scroll restriction process. By touching the scroll restriction process setting button 83 and sliding the touched position in the horizontal direction while keeping the touched state, ON/OFF of the scroll restriction process can be switched. The touch panel 12 receives the setting for determining whether or not to perform the scroll restriction process when the operation for moving the button image 72 is made in the state where the mark image 9 is displayed. The processing unit 10 performs the scroll restriction process when the setting for performing the scroll restriction process is made, while it does not perform the scroll restriction process when the setting for not performing the scroll restriction process is made. In this way, the user can select whether or not to perform the scroll restriction process. Thus, the display device 1 can operate as the user intends.

(Groove Image Change Mode)

Next, with reference to FIGS. 6 and 13 to 15, the groove image change mode according to the embodiment is described. The display device 1 also has a mode for changing the horizontal width of the groove image 73 according to the contents end position E (groove image change mode). With reference to FIG. 13, a flow of the groove image change mode is described. The flow of FIG. 13 starts when browsing of the page P such as a web page is started with the display device 1. In addition, the flow of FIG. 13 is repeated until the browsing of the page P is finished (until being switched to another screen).

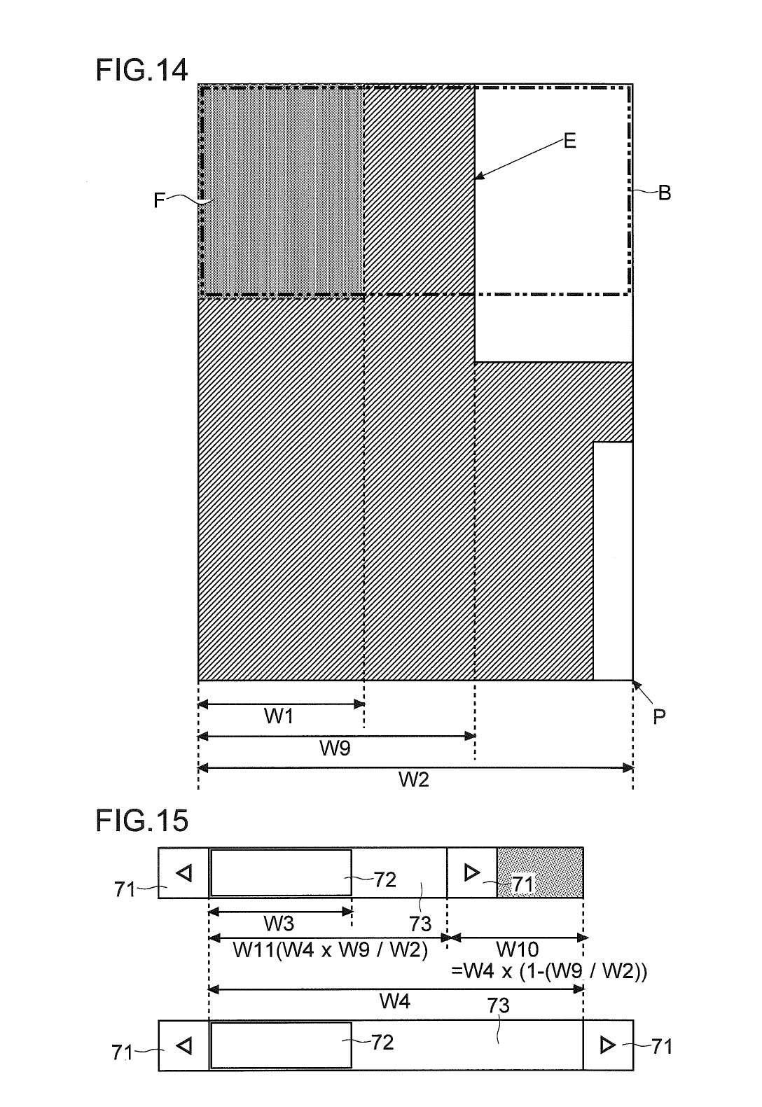

First, the processing unit 10 determines the contents end position E that is the rightmost position of the contents in the band area B from the left end to the right end of the page P overlapping with the display area F of the display panel 11 (Step #21, similarly to Step #11 in FIG. 7). In FIG. 14, the line indicating the right end position of the contents in the page P is illustrated by a solid line. The processing unit 10 recognizes this line. The processing unit 10 determines the rightmost position among the right end positions of the contents in individual lines in the band area B as the contents end position E. In addition, when structuring and arranging the page P, the right end position of the contents in each line of the left and right direction included in the page P may be recognized and stored, in the same manner as in Step #11.

The processing unit 10 determines whether or not it is necessary to change the horizontal width of the groove image 73 (Step #22). When the contents end position E is the right end of the page P (when it overlaps with the right end), the processing unit 10 determines that it is not necessary to change the horizontal width of the groove image 73. When the contents end position E is inside the right end of the page P (when it does not overlap with the right end), the processing unit 10 determines that it is necessary to change the horizontal width of the groove image 73.

When changing the horizontal width of the groove image 73 (Yes in Step #22), the processing unit 10 calculates a ratio between the horizontal width of the page P and the distance from the left end of the page P to the contents end position E (Step #23). In FIG. 14, the display area F in the page P is shown by a rectangle with hatching. FIG. 14 illustrates an example of the state where the display panel 11 displays the upper left part of the page.

In FIG. 14, the left and right width (entire width) of the display area F of the display panel 11 is shown by the horizontal width W1. In addition, in FIG. 14, the left and right width (entire width) of the entire page is the horizontal width W2. In addition, in FIG. 14, the distance from the left end of the page P to the contents end position E is shown by a horizontal width W9. In the state of FIG. 14, the processing unit 10 calculates the ratio of the horizontal width W9 to the horizontal width W2 in Step #23.

Next, the processing unit 10 multiplies the entire width of the groove image 73 (reference horizontal width) by the value of one minus the ratio so as to calculate the length (Step #24). In FIG. 15, the entire width (left and right width) of the groove image 73 before the change (in a normal state) is shown by the horizontal width W4. In addition, in FIG. 15, the length obtained by multiplying the entire width of the groove image 73 by the value of one minus the ratio is shown by a horizontal width W10. In FIG. 15, a relationship of W4×(1−(horizontal width W9)/(horizontal width W2))=(horizontal width W10) is satisfied. In addition, in FIG. 15, a width obtained by multiplying the entire width of the groove image 73 by the calculated ratio is shown by a horizontal width W11.

Further, the processing unit 10 controls the display panel 11 to display the groove image 73 having a length shortened from the reference horizontal width by the calculated length (Step #25). In this way, the user can know that the state where the button image 72 has reached the right end of the groove image 73 is the state where there are no contents to be newly displayed by the right scroll. In addition, the right end of the groove image 73 included in the scroll bar corresponds to the contents end position E of the band area B. Therefore, when using the horizontal scroll bar 7, it is possible to inhibit movement (scroll) of the display area F to the right side of the contents end position E. Thus, wasteful right scroll can be prevented.

The reference horizontal width is the horizontal width of the groove image 73 in the normal state (before the change). In other words, the reference horizontal width is the horizontal width of the groove image 73 when the contents end position E is the right end of the page P so that the horizontal width is not changed. Note that the horizontal width of the button image 72 is not changed. In other words, the horizontal width of the button image 72 is the horizontal width when the groove image 73 has the reference horizontal width ((reference horizontal width of groove image 73)×(horizontal width of display area F)/(horizontal width of page P)).

In other words, the processing unit 10 sets the horizontal width of the groove image 73 to be shorter than the reference horizontal width that is the horizontal width of the groove image 73 when there are the contents to the right end of the band area B, so that the state where the button image 72 reaches the right end of the groove image 73 is the state where the right end of the display area F overlaps with the contents end position E (groove image change mode). In this way, it is possible to visually show to the user that there are no contents to the right end area of the band area B and the right end area of the band area B is blank. In addition, it is possible to forcibly prevent the right scroll that does not cause display of new contents. Thus, a wasteful right scroll operation can be eliminated.

FIG. 15 illustrates an example in which the right end of the groove image 73 is shortened by the calculated length. By shortening, the position of the arrow image 71 is moved. An area eliminated from the groove image 73 by shortening is filled with gray color (is gray out).

In the case of No in Step #22 (when it is not necessary to change the horizontal width of the groove image 73), and after Step #25, the flow returns to Step #21. The processing unit 10 performs Step #21 at a constant period during display of the page P. In this way, even if the display area F of the display panel 11 is moved, the horizontal width of the groove image 73 becomes a position corresponding to the contents end position E.

In this way, the display device 1 according to the embodiment includes the display panel 11 that displays contents of the page P and the horizontal scroll bar 7 including the button image 72 and the groove image 73 indicating a slide range of the button image 72, the touch panel (touch panel 12) provided to the display panel 11 so as to receive an operation to a displayed image, and the processing unit 10 that controls display on the display panel 11, recognizes content of the operation to the displayed image based on an output of the touch panel, and moves the display area F of the display panel 11 in the horizontal direction according to a movement direction and a movement amount of the button image 72 of the horizontal scroll bar 7. When the horizontal width of the page P is larger than the horizontal width of the display area F of the display panel 11, the processing unit 10 determines the contents end position E that is a rightmost position of the contents in the band area B that is an area in the page P having an upper end and a lower end respectively corresponding to the upper end and the lower end of the display area F of the display panel 11 from the left end to the right end of the page P, and controls the display panel 11 to display the horizontal scroll bar 7 indicating the contents end position E.

In this way, the user can know that there are no contents to the right end of the current display area F on the display panel 11. In other words, the user can know that there are no new contents to be displayed from a midpoint when scrolling to the right end. Further, the user can be informed that the right scroll until reaching the right end is wasteful. Thus, the wasteful right scroll that does not cause display of new contents can be eliminated.

In addition, the image forming apparatus (the multifunction peripheral 100) includes the display device 1 according to the embodiment. Accordingly, it is possible to provide the image forming apparatus (multifunction peripheral 100), in which the user can visually recognize that there are no contents to the right end of the page P in the current band area B, and that the scroll of the display area F to the right side of the contents end position E (area with only a blank part) is wasteful.

In the example described above, there is described the display of the horizontal scroll bar 7 on the smart phone, the tablet computer, or the dedicated display device 1 for the multifunction peripheral 100, equipped with the touch panel 12. However, the present disclosure can be applied not only to the smart phone, the tablet computer, or the dedicated display device 1 for the multifunction peripheral 100, but also to an information processing device such as a PC. In this case, a display of the information processing device corresponds to the display panel 11 that displays contents of the page P and the horizontal scroll bar 7 including the button image 72 and the groove image 73 indicating a slide range of the button image 72. An input device such as a mouse or a keyboard corresponds to the touch panel that receives operation to the displayed image. A control substrate in the PC corresponds to the processing unit 10 that controls display on the display, recognizes content of the operation to the displayed image based on an output of the touch panel such as a mouse, and moves the display area F of the display in the horizontal direction based on a movement direction and a movement amount of the button image 72 of the horizontal scroll bar 7. Further, when a horizontal width of the page P is larger than a horizontal width of the display area F of the display, the control substrate determines the contents end position E that is a rightmost position of the contents in the band area B that is an area in the page P having an upper end and a lower end respectively corresponding to the upper end and the lower end of the display area F of the display panel 11 from the left end to the right end of the page P, and controls the display to display the horizontal scroll bar 7 indicating the contents end position E.

In addition, although the embodiment of the present disclosure is described above, the scope of the present disclosure is not limited to the embodiment, and the present disclosure can be variously modified in the scope without deviating from the spirit of the disclosure.

What is claimed is:

1. A display device comprising:
a processing unit including a control circuit;
a display panel configured to display contents of a page by control by the processing unit, and to display a horizontal scroll bar including a button image indicating a current display position and a groove image indicating a slide range of the button image; and
a touch panel provided to the display panel so as to receive an operation to a displayed image, wherein
the processing unit recognizes content of the operation to the displayed image based on an output of the touch panel, and moves a display area of the display panel in a horizontal direction based on a movement direction and a movement amount of the button image of the horizontal scroll bar, and wherein
when a horizontal width of the page is larger than a horizontal width of the display area of the display panel, the processing unit determines a contents end position that is a rightmost position of the contents in a band area that is an area in the page having an upper end and a lower end respectively corresponding to an upper end and a lower end of the display area of the display panel from a left end to a right end of the page, and controls the display panel to display the horizontal scroll bar indicating the contents end position.

2. The display device according to claim 1, wherein the processing unit controls the display panel to display a mark image as information indicating the contents end position, and controls the display panel to display the mark image so that a state where the right end of the button image overlaps with the mark image becomes a state where the right end of the display area overlaps with the contents end position.

3. The display device according to claim 2, wherein the processing unit controls to display the mark image in a frame of the groove image, calculates a ratio of a distance from a left end of the page to the contents end position to the horizontal width of the page, multiplies an entire width of the groove image by the ratio to calculate a length, and controls to display the mark image at a position on a right side away from the left end of the groove image by the calculated length.

4. The display device according to claim 2, wherein when an operation for moving the button image is made in a state where the mark image is displayed, the processing unit performs a scroll restriction process for inhibiting movement of the right end of the button image to the right side of the mark image.

5. The display device according to claim 4, wherein
the touch panel receives setting for determining whether or not to perform the scroll restriction process when the operation for moving the button image is made in the state where the mark image is displayed, and
the processing unit performs the scroll restriction process when setting for performing the scroll restriction process is made, and does not perform the scroll restriction process when setting for not performing the scroll restriction process is made.

6. The display device according to claim 1, wherein when controlling the display panel to display the horizontal scroll bar indicating the contents end position, the processing unit sets a horizontal width of the groove image shorter than a reference horizontal width that is the horizontal width of the groove image when there are contents to the right end of the band area, and a state where the button image reaches the right end of the groove image is a state where the right end of the display area overlaps with the contents end position.

7. The display device according to claim 6, wherein the processing unit calculates a ratio of a distance from the left end of the page to the contents end position to the horizontal width of the page, multiplies the reference horizontal width by a value of one minus the ratio to calculate a length, and controls the display panel to display the horizontal scroll bar having the horizontal width of the groove image shorter than the reference horizontal width by the calculated length.

8. The display device according to claim 1, wherein the processing unit controls the display panel to display the horizontal scroll bar corresponding to a mode selected by an operation to the touch panel, from a mark image mode in which the horizontal scroll bar with a mark image indicating the contents end position is displayed on the display panel, and a groove image change mode in which the horizontal scroll bar having the horizontal width of the groove image shorter than a reference horizontal width that is the horizontal width of the groove image when there are contents to the right end of the band area is displayed on the display panel.

9. An image forming apparatus comprising the display device according to claim 1.

10. A method for controlling a display device, the method comprising:
displaying on a display panel contents of a page and a horizontal scroll bar including a button image indicating a current display position and a groove image indicating a slide range of the button image;
receiving an operation to a displayed image with a touch panel provided to the display panel;
recognizing content of the operation to the displayed image based on an output of the touch panel;
moving a display area of the display panel in a horizontal direction based on a movement direction and a movement amount of the button image of the horizontal scroll bar;
determining a contents end position that is a rightmost position of the contents in a band area that is an area in the page having an upper end and a lower end respectively corresponding to an upper end and a lower end of the display area of the display panel from a left end to a right end of the page, when a horizontal width of the page is larger than a horizontal width of the display area of the display panel; and
displaying on the display panel the horizontal scroll bar indicating the contents end position.
